(19) United States
(12) Patent Application Publication
(10) Pub. No.: US 2009/0291281 A1
(43) Pub. Date: Nov. 26, 2009

(54) Microfiller-Reinforced Polymer Film

(76) Inventor: Gregory M. Hanket, Newark, DE (US)

Correspondence Address: The Weintraub Group, 32000 Northwestern Highway, Suite 240, Farmington Hills, MI, 48334, US

(21) Appl. No.: 11/795,725

(22) PCT Filed: Jan. 20, 2006
(86) PCT No.: PCT/US06/02062

§ 371 Date: Jul. 20, 2007

Related U.S. Application Data
(60) Provisional application No. 60/645,202, filed on Jan. 20, 2005.

(51) Int. Cl. B32B 5/02; B32B 27/04; B29C 55/02

(52) U.S. Cl. 428/220; 428/338; 264/175; 264/288.4

(57) ABSTRACT

The present invention comprises microfiller-reinforced polymer films. Microfiller-reinforced polymer films are films having high aspect-ratio fillers incorporated therewith, which filler have a minor dimension less that 20 μm and a major dimension at least three times greater than the minor dimension.

### CROSS REFERENCE TO RELATED APPLICATIONS

This application is a completion application of copending U.S. Provisional Patent Application 60/645,202, filed Jan. 20, 2005, for “Microfiller-Reinforced Polymer Film”, the entirety of which is hereby incorporated by reference.

### BACKGROUND

1. Field of the Invention

The present invention relates to microfiller-reinforced polymer films for use, among other applications, as substrates for thin film deposition as in the fabrication of flexible flat-panel displays and solar cells, as laminates in flex circuits, and in other applications where improved mechanical properties over traditional polymer films are desired.

2. Prior Art

High performance polymer films, utilizing classes of polymers such as polyesters, polyimides, polyetherimides, and polyetheretherketones are currently in widespread use. These films are characterized by their relatively high elastic moduli, low coefficients of thermal expansion, and tolerance to high temperatures.

Among other applications, high performance polymer films are used as electrically insulating laminates for the fabrication of “flex-circuits.” Flex-circuits, generally, comprise patterned copper (either foil or deposited) laminated between polymer films. Polymer films have also been used as substrates for numerous thin film deposition processes, including the manufacture of thin film solar cells, the manufacture of which requires the substrate to survive temperatures exceeding 400° C.

Another highly desirable application is as a substrate for flexible flat panel displays, whose manufacture may also require process temperatures approaching 400° C. However, these polymer films are not entirely suitable for some types of displays due to their coloration, coefficient of thermal expansion, inadequate melting or glass-transition temperatures, inadequate dimensional stability, etc.

Yet another highly desirable application is as a high strength composite tape or film that can be laminated into sheets or wound into geometric forms such as tubes. These forms can then be thermoformed into more complex geometries, given the use of an appropriate film composition and adhesive technique.

Further, the coefficient of thermal expansion of polymer films is typically greater than some of the thin films that may be deposited on them, e.g. silicon films for thin film transistor arrays and sputtered molybdenum films for the manufacture of solar cells. As an example of the thermal expansion mismatch in the deposition of some metallic thin films onto polymer films, the lowest cited coefficient of thermal expansion (CTE) for a polyimide film is 12 ppm/° C., while silicon has a coefficient of thermal expansion of only 2.5 ppm/° C., and molybdenum of about 6 ppm/° C. When taken to a sufficiently high temperature, the thermal expansion mismatch between the metal and polymer film may cause fracturing of the metal film, causing visible texturing of the film and a discontinuity in the lateral electrical conduction.

Furthermore, the properties of polymer films may be dependent on the thermal history of the film. Properties such as coefficient of thermal expansion and modulus are, therefore, dependent not only on the controllability of the manufacturing process, but also any history of subsequent high temperature processing.

The present invention seeks to improve the properties of existing polymer films by providing a microfiller-reinforced polymer film, and corresponding fabrication process, that has a reduced coefficient of thermal expansion, increased strength and elastic modulus, improved dimensional stability, and reduced variability of properties due to either process variations or thermal history. Additionally, the microfiller-reinforced film may in some cases be more cost effective than an unfilled film, owing to 1) the lower cost of the microfiller compared to polymer film precursors and 2) the increased stiffness of the film due to the microfiller and corresponding reduction in required film thickness and weight to meet given stiffness or strength requirements.

### SUMMARY OF THE INVENTION

The present invention comprises microfiller-reinforced polymer films. Microfiller-reinforced polymer films are films having high aspect-ratio fillers incorporated therewith, which fillers have a minor dimension less than 20 μm and a major dimension at least three times greater than the minor dimension.

Useful microfillers include microflakes, microfibers, microribbons, and the like.

Generally, the film will comprise from about 1% to about 99% of the volume of the film and, preferably, from about 15% to about 20% of the film volume.

The present films are manufactured by dispersing the filler in the polymer melt, resin or other precursor prior to extruding, casting or otherwise forming the film.

The tensile strength of the films can be increased by drawing the filler-reinforced films in a uniaxial direction at a temperature between the glass transition and melt temperature of the film. The drawing or elongation can be achieved by calendering or otherwise unidirectionally elongating the film. The strength enhancement of the matrix achieved by elongation reduces the probability of fiber pullout by cohesive matrix failure, thereby improving the utilization of the fiber strength.

The so-produced films hereof may be laminated by using two-part adhesives with one part applied to one surface of a film and the other part applying to an abutting surface of the other film and contacting the two surfaces together with or without heat and/or pressure depending on the adhesive. Suitable adhesives include urethane adhesives, epoxies, etc.

For a more complete understanding of the present invention reference is made to the following detailed description and accompanying example.

### DESCRIPTION OF THE PREFERRED EMBODIMENTS

As noted, the present invention provides a microfiller-reinforced polymer film. As used herein, the term “microfiller” denotes a “high-aspect-ratio” filler, i.e. one having a minor dimension less than 20 μm and a geometry wherein the major dimension of the filler is at least three times greater than the minor dimension. Examples of such high aspect-ratio microfillers include, for example, (a) a microfiber with a diameter less than 20 μm and a length greater than 3 times the diameter; (b) a microflake with a thickness less than 20 μm and width and length greater than 3 times the thickness; and (c) a microribbon with a thickness less than 20 μm and a length greater than 3 times the thickness.

It is this “high aspect-ratio” microfiller dispersed in a polymer matrix in the form of a film that defines the present invention. It should be noted that as used herein, and as understood in the art, the term “film” signifies a polymer film having a thickness less than 0.010 inch. The ratio of the composite film thickness to the minor dimension of the filler is at least 2 to 1 and usually ranges from about 20 to 1 to about 50 to 1.

The presence of the high aspect-ratio microfiller in the film serves to increase the modulus of elasticity and decrease the CTE, and otherwise stabilize the physical dimensions of the film, for example, by reducing certain effects such as irreversible film shrinkage normally occurring at high temperatures.

The high aspect ratio of the microfiller is critical to the practice of the present invention. Instead of simply “averaging” the polymer and microfiller properties, the high aspect ratio microfiller induces a shear strain into the polymer surrounding the microfiller, thereby weighting the film properties disproportionately to those of the microfiller. By suitably choosing the polymer and microfiller compositions and ratios, it is theoretically possible to match the film CTE to some metals such as copper and aluminum. This renders the present microfiller-reinforced film desirable as a substrate material.

In practicing the present invention, the useful microfillers are, for example, glass microfibers, metal-coated glass microfibers, carbon microfibers, ceramic microfibers, metal microfibers or microwires, microfibers of a polymer or polymers dissimilar in composition to the film matrix, natural or artificially produced silk microfibers, mineral microfibers such as asbestos, naturally occurring plant or animal microfibers, glass microflakes or microribbons, metal-coated glass microflakes or microribbons, carbon microflakes or microribbons, ceramic microflakes or microribbons, metal microflakes or microribbons, microflakes or microribbons of a polymer or polymers dissimilar in composition to the film matrix, mineral microflakes or microribbons such as mica, naturally occurring plant or animal microflakes or microribbons, blends of any or all of the aforementioned microfillers, and the like. Preferably, for substrate applications where good optical transparency is desired, the microfiller comprises a glass microflake, such as that sold commercially under the name MicroGlas® REF-160 by NGF Canada.

For applications, such as high modulus tapes, where mechanical properties are of utmost importance and optical properties and film isotropy may be neglected, the microfiller is, preferably, a carbon microfiber. It should be noted, though, that the preferred microfiller and its quantity are usually selected in response to the desired film properties such as strength, modulus, weight, film transparency, electrical conductivity, and coefficient of thermal expansion.

In preparing a film in accordance herewith, the microfiller is ordinarily present in an amount ranging from about 1% to about 99% of the volume of the film. Preferably, the microfiller is present in an amount ranging from about 15% to about 20% of the film volume. The amount of microfiller is selected depending on the microfiller properties, polymer properties, and desired properties of the resultant film. Again, though, the microfiller quantity may be varied to yield the desired properties for the resultant film.

It should be noted that the manufacturing process can also be used to control film properties. For example, by varying the quench rate of some extruded thermoplastics it is possible to influence index of refraction and haze value. Specifically, the optical properties of a polyethylene terephthalate (PET) film are known to be controllable to some degree using a quench roller film casting process.

The microfiller is incorporated into the film by dispersing it in a polymer melt, resin, or other liquid precursor before extruding, casting, or otherwise forming the film. Such methods or techniques are currently known in the art. Alternately, the film may be formed by impregnating a nonwoven microfiber mat with the polymer melt, resin, or liquid precursor.

In use the microfiller may be randomly dispersed and oriented or may be directionally oriented, as required. The generally occurring alignment of fibers due to flow is well known, and contributes to some degree of anisotropy of the resultant film. The maximization of anisotropy may be desirable in the manufacture of high modulus tapes, or for achieving anisotropy of electrical properties if a conductive microfiber is utilized. However, anisotropy is generally not desirable in the manufacture of films intended for use as substrates. In this case, microflakes are a preferred filler. Alternately, tentering or stentering (stretching the film in the transverse direction) of a microfiber-filled film may be used to decrease film an isotropy.

Since the presence of the microfiller near the film surface may negatively influence the smoothness of the film surface, the film may be calendered at an appropriate point in the manufacturing process in order to improve the surface finish.

The presence of “high aspect ratio” microfillers does not preclude the simultaneous presence of other well known functional fillers conjointly therewith. These functional fillers may be used to modify the chemical or optical properties of the film. An illustrative example is the addition of TiO2 particles to reduce polymer degradation due to ultraviolet light.

Among the useful polymers for use herein are the previously mentioned polyimides, polyetherimides, polyetheretherketones, and polyesters, such as polyethylene terephthalate (PET) and polyethylene naphthalate, as well as liquid crystal polymers, polyamides, polyethersulfones, phenolics, silicones and silicone rubbers, and the like.

The present invention has particular utility in the manufacture of a transparent substrate for deposition of a silicon thin film transistor (TFT) array for manufacture of a flexible flat panel display. In manufacturing such a substrate, generally, a 40% by weight E-glass microflake is blended into a PET melt prior to forming the film. The E-glass microflake is used because of the resultant low anisotropy, reduced refractive scattering owing to the filler geometry, and its close refractive index match to PET (1.56 to approximately 1.6), thereby retaining as much film transparency as possible. Processing of the silicon film is known such as disclosed in U.S. Pat. No. 6,642,085, the disclosure of which is hereby incorporated by reference. During processing of the silicon film, the film is heated above its glass transition temperature, above which the properties of unreinforced polyester become highly variable and ill defined. Reinforcement of the film by the glass microflake moderates the variability of film properties, such as CTE and modulus, above this temperature.

In another embodiment hereof there is provided a microfiber-filled polyimide film prepared by solvent casting for use in high temperature, high modulus applications. Polyimide films are synthesized by the reaction of a dianhydride, such as pyromellitic dianhydride, and a diamine, such as 4-4′ oxydianiline (ODA). These substances are typically powders under ambient conditions. In forming a film therefrom they are dissolved in a 1:1 mole ratio in an appropriate solvent, such as n-methylpyrrolidone (NMP) where they react to form poly(amic acid) chains. The microfiller, such as an 0.5 μm diameter borosilicate microfiber, is then blended into this solution to a weight ratio of from about 1:6 to about 1:3 to the poly(amic acid). The solvent weight fraction in the poly(amic acid)/microfiber/solvent composition may be as high as 95% before extrusion. This poly(amic acid)/solvent/microfiller composition is extruded onto a continuous belt, then heated to a temperature of about 100° C. to drive off the solvent resulting in a solid film. Due to the incorporation of the microfiller, the film may be expected to exhibit texturing on the upper surface (that surface opposite to that in contact with the belt). Smoothing of the upper surface can be accomplished by the extrusion of a second non-filled poly(amic acid)/solvent film on top of the original microfiller/poly(amic acid)/solvent film followed by a second solvent bake-off. Alternately, smoothing may be accomplished by using calender rollers on the poly(amic acid) film to smooth the film after disengagement from the belt. The resultant film is then lifted off the belt, supported on either side with a minimum amount of stress, carried through a furnace, and thermally imidized to convert the poly(amic acid) chains to polyimide via a dehydration reaction. Imidization can be accomplished by a variety of cure cycles, with higher cure temperatures requiring shorter cure times. Typical curing is conducted by ramping the temperature from about 100° C. to about 300° C. over a period of about three hours, or by an approximately half-hour cure at 400° C.

Microfiber mats may be used herein. Where used, they are associated with the film by impregnating the melt with a thermoplastic melt, resin, or precursor solution. In the case of a polyimide, for example, the mat is impregnated with the poly(amic acid)/solvent composition, then heated to drive off the solvent, resulting in a mat impregnated with poly(amic acid). The resultant microfiber/poly(amic acid) mat may then be imidized as discussed hereinabove.

In manufacturing the present films it should be noted that and as indicated above, non-microfillers may be used herein in conjunction with the microfillers. Furthermore, in order to strengthen the films hereof the tensile strength can be significantly improved by subjecting the film to a uniaxial orientation. Generally speaking, uniaxial orientation is achieved by drawing the fiber-containing film at a temperature between the glass transition temperature and the melting temperature of the film. The drawing of the film can be achieved through any suitable technique. However, it is preferred that either calendering which is also used to remove texturing or extrusion of the film through a die be used. It should be noted that the uniaxial orientation for increasing tensile strength in unreinforced PET films is taught such as in U.S. Pat. No. 6,589,463, the disclosure of which is hereby incorporated by reference.

In calendering the film, a thick solidified film may be fed through the calendering train in a single or a multiple passes through the calendering nips. The rolls or nips are maintained at temperatures between the glass transition and melting temperature of the thermoplastic polymer resin.

The calendering process may be used not only with semi-crystalline polymer such as PET but also liquid crystalline polymers as well as amorphous polymers such as glycol-modified PET (PETG). The orientation effects will be much less prevalent in amorphous polymers, however.

The present fiber-reinforced films may also be used for the manufacture of high strength tapes and composite forms. Composite forms may be fabricated by laminating the fiber-reinforced films either by thermally bonding the pieces together or by using an adhesive such as a two part adhesive including urethane adhesives, epoxy adhesives, acrylate adhesives and other well known two part adhesives. Multiple bi-coated films or tapes, i.e. one adhesive component on one side and the second adhesive component on the opposite side, can be wrapped or coiled around a form. Storage of bi-coated films can be adhered by placing a waxed-paper backing over the adhesive components to prevent contact between the two components until using is desired. Single component adhesives, such as melt bonding adhesives, pressure sensitive adhesives, etc. may also be used.

Where thermal bonding is utilized for oriented films, it is important not to exceed the melting temperature of the polymer so that the matrix orientation is not lost. By applying appropriate pressure at temperatures exceeding the glass transition temperature, but below the melt temperature, it is anticipated that individual plies may be fused without use of a separate adhesive.

As noted hereinabove, the microfillers hereof may be used alone or in conjunction with other fillers including nanoscale fillers such as carbon nanotubes and the like. Other useful fillers include silicates, kieselguhr-larths, talc, mica, fumed silica, clays, the aforementioned metal flakes, magnesium particles, glass, etc.

Following is an illustrative non-limiting example of the present invention where all parts are by weight absent contrary indications.

### EXAMPLE

This example illustrates the preparation of a microfiber-filled polyimide film.

One part of a glass microfiber, sold commercially by West System, under the name #403 Microfibers is blended at room temperature into 4 parts solution poly(amic acid) solution. The poly(amic acid) solution comprises 13 parts poly(pyromellitic dianhydride-co-4,4′-oxydianiline), 70 parts n-methylpyrrolidone, and 17 parts aromatic hydrocarbon, and is sold commercially under the product number 57,579 by Aldrich Chemical.

The resultant slurry is blotted onto a glass slide and baked for 15 minutes at 75° C. in ambient atmosphere to drive off the n-methylpyrrolidone/aromatic hydrocarbon solvent. The resultant self-supporting microfiber/poly(amic acid) film is peeled from the glass slide. The upper side of the film exhibits a texturing due to the presence of the glass microfiber in the film.

Moreover, in another aspect hereof, it is possible, by suitably choosing polymer and microfiller compositions with similar indices of refraction, that film transparency may be maximized. Conversely, polymer and microfiller compositions with disparate indices of refraction will provide products having increased light diffusivity and reflection within the film.

Having, thus, described the invention, what is claimed is:

1. A microfiller-reinforced polymer comprising:
a. thin film polymer having microfiller incorporated therewith, the microfiller being a high aspect-ratio filler having a minor dimension less than 20 μm and a major dimension of at least three times that of the minor dimension.

2. The polymer film of claim 1 wherein the microfiller is selected from the group consisting of microflakes, microfibers and microribbons.

3. The film of claim 1 wherein the ratio of the composite film thickness to the minor dimension is at least two to one.

4. The film of claim 3 wherein the ratio of the composite film thickness to the minor dimension ranges from about twenty to one to about fifty to one.

5. The film of claim 1 wherein the microfiller is present in an amount ranging from about 1% to about 99% of the volume of the film.

6. The film of claim 5 wherein the microfiller is present in an amount ranging from about 15% to about 20% of the film volume.

7. The film of claim 1 wherein the film is a polymeric film, the polymer being selected from the groups consisting of polyimides, polyetherimides, polyetheretherketones, polyesters, liquid crystal polymers, polyomides, polyether sulfates, phenolics, silicone polymers and silicone rubbers.

8. The film of claim 7 wherein the polymer is a polymide.

9. The film of claim 1 wherein the microfiller is selected from the group consisting of glass microfibers, metal-coated glass microfibers, carbon microfibers, ceramic microfibers, metal microfibers, microwires, glass microflakes, microribbons, ceramic microflakes and microribbons, metal microflakes and microribbons, microflakes and microribbons of a polymer or polymers dissimilar in composition to the film matrix, mineral microflakes and microribbons and mixture thereof.

10. The film of claim 9 wherein: (a) the microfiller is selected from the group consisting of glass microfibers, metal-coated glass microfibers, carbon microfibers, ceramic microfibers, metal microfibers, polymeric microfibers of a polymer different than that of the film, silk microfibers, mineral microfibers, naturally occurring plant and animal microfibers, (b) the microflakes are selected from the group consisting of glass, metal-coated glass, carbon, ceramic, metal, polymeric microflakes of a polymer different than that of the film, silk, mineral, naturally occurring plant and animal microflakes, and (c) the microribbons are selected from the group consisting of glass, metal-coated glass, carbon, ceramic, polymeric microribbons of a polymer different than that of the film, silk, mineral, naturally occurring plant and animal microribbons.

11. A process for the manufacture of a microfiller reinforced polymer film, comprising: elongating the film at a temperature between its glass transition temperature and melting temperature and wherein the film is elongated by either calendering or drawing the film.
